(19) United States
(12) Patent Application Publication
(10) Pub. No.: US 2024/0330779 A1
(43) Pub. Date: Oct. 3, 2024

(54) MACHINE-LEARNING MODEL-BASED LIFE-CYCLE CLASSIFICATION FOR SELECTION OF A FORECASTING MODEL

(71) Applicant: Oracle International Corporation, Redwood Shores, CA (US)

(72) Inventors: Debdatta Sinha Roy, Boston, MA (US); Joana Urbano, Coimbra (PT); Kiran Venkata Panchamgam, Bedford, MA (US)

(73) Assignee: Oracle International Corporation, Redwood Shores, CA (US)

(21) Appl. No.: 18/324,454

(22) Filed: May 26, 2023

Related U.S. Application Data
(60) Provisional application No. 63/493,643, filed on Mar. 31, 2023.

(51) Int. Cl. G06N 20/20; G06Q 10/04

(52) U.S. Cl. CPC G06N 20/20; G06Q 10/04

(57) ABSTRACT

Techniques for training a machine learning model to generate life-cycle classifications for product-store pairs are disclosed. A system generates training data sets for training a machine learning model by comparing sets of time-series data to a set of feature-based rules mapped to life-cycle labels. The system trains the machine learning model using the training data sets to classify time-series data associated with product-store pairs. The system applies the trained machine learning model to a particular set of time-series data for a particular product-store pair, such as sales data for a particular product at a particular store. The machine-learning model generates a life-cycle classification for the set of time-series data and the corresponding product-store pair. The system selects a forecasting model to forecast attributes of the product-store pair based on the life-cycle classification.

### INCORPORATION BY REFERENCE; DISCLAIMER

The following application is hereby incorporated by reference: application No. 63/493,643, filed Mar. 31, 2023. The applicant hereby rescinds any disclaimer of claims scope in the parent application(s) or the prosecution history thereof and advise the USPTO that the claims in the application may be broader than any claim in the parent application(s).

### TECHNICAL FIELD

The present disclosure relates to implementing a machine learning model for generating a life-cycle classification for a product at a particular store (referred to herein as a product-store pair). The classification is used to select a corresponding forecasting model for forecasting one or more attributes associated with the product-store pair.

### BACKGROUND

Enterprises use demand-forecasting algorithms to predict demand for products. These algorithms identify variations in sales, prices, and inventory in time-series data. One class of products that tends to sell year-round from certain locations is referred to as a long-life-cycle product (LLC). Another class of products that only sells for a particular season, or for a limited duration of time, less than year-round, from a particular location is referred to as a short-life-cycle product (SLC). Forecasting models that are effective at forecasting attributes for LLC products are not effective at forecasting attributes for SLC products. Likewise, forecasting models that are effective at forecasting attributes for SLC products are not effective at forecasting attributes for LLC products.

Traditionally, due to the large variety of products at various locations for a retailer, enterprises categorize all products for a particular retailer as one product type. For example, grocery retailers are generally considered long-life-cycle businesses and fashion retailers are generally considered short-life-cycle businesses. An enterprise with ten grocery locations and thousands of products at each location will typically apply an LLC-type forecasting model to all the products at the locations. However, there are many exceptions to this type of life-cycle generalization. For example, some grocery products, such as eggnog, are SLC-type products sold primarily during one season. Likewise, a clothing item such as a generic t-shirt may be an LLC-type product sold year-round.

Retailers track individual products using stock keeping units (SKU). SKUs are unique codes consisting of letters and numbers that identify characteristics of each product. A mid-sized retailer in the United States has tens or hundreds of retail locations. Each location may have distinct product attributes (e.g., sales, inventory, pricing, and promotions). Accordingly, for a mid-sized retailer, forecasting attributes for each product at each store corresponds to forecasts for a few million SKU-store combinations, typically performed at weekly intervals. Large retailers typically would have millions of SKU-store combinations for which the retailer could forecast product attributes. To date, no existing forecasting process has been able to classify each SKU-store combination as SLC or LLC. Nor is such a classification practical to be performed by humans. Changing inventories and trends mean that by the time a retailer was able to classify each SKU-store combination as SLC or LLC, the retailer's inventory would have changed and previously-generated classifications may no longer apply. Since retailers have been unable to overcome this problem, the retailers typically generate broad categorizations for particular locations of classes of products. For example, a grocery retailer may typically label all grocery items as LLC-type goods and all seasonal items as SLC-type goods for forecasting purposes. Such over-generalization may result in forecasting inaccuracies for particular products that are exceptions to the generalization.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### BRIEF DESCRIPTION OF THE DRAWINGS

The embodiments are illustrated by way of example and not by way of limitation in

the figures of the accompanying drawings. It should be noted that references to “an” or “one” embodiment in this disclosure are not necessarily to the same embodiment, and they mean at least one. In the drawings:

FIGS. 1A and 1B illustrate a system in accordance with one or more embodiments;

FIGS. 2A and 2B illustrate an example set of operations for training a machine learning model to generate life-cycle classifications in accordance with one or more embodiments;

FIGS. 3A-3E illustrate an example embodiment; and

FIG. 4 shows a block diagram that illustrates a computer system in accordance with one or more embodiments.

### DETAILED DESCRIPTION

In the following description, for the purposes of explanation, numerous specific details are set forth in order to provide a thorough understanding. One or more embodiments may be practiced without these specific details. Features described in one embodiment may be combined with features described in a different embodiment. In some examples, well-known structures and devices are described with reference to a block diagram form in order to avoid unnecessarily obscuring the present invention.
1. GENERAL OVERVIEW
2. SYSTEM ARCHITECTURE
3. TRAINING MACHINE LEARNING MODEL TO GENERATE LIFE-CYCLE CLASSIFICATIONS FOR PRODUCT-STORE PAIRS
4. EXAMPLE EMBODIMENT
5. PRACTICAL APPLICATIONS, ADVANTAGES, AND IMPROVEMENTS
6. COMPUTER NETWORKS AND CLOUD NETWORKS
7. MISCELLANEOUS; EXTENSIONS
8. HARDWARE OVERVIEW

### 1. General Overview

Demand forecasting is a vital process for retailers to increase profitability. The sales patterns of different products may differ between products and between different locations for the same product. To accurately forecast demand for products, a company may use one type of model to forecast trends associated with “long life cycle” (LLC) products and a different type of model to forecast trends associated with “short life cycle” (SLC) products.

One or more embodiments train a machine learning model to classify a product at a particular store (referred to herein as a product-store pair) as having a long life cycle (LLC) or short life cycle (SLC). A system generates training data sets by comparing sets of time-series data to a set of feature-based rules mapped to LLC and SLC labels. The sets of time-series data include sales data for a particular product at a particular store (i.e., product-store pair). Since one product may have different sales characteristics in different regions or different stores, the same product sold from two different stores corresponds to two different sets of time-series data. The system assigns life-cycle classifications to the sets of time-series data based on detecting a match. According to one embodiment, the set of feature-based rules is a hierarchical set. The system compares a set of time-series data to a first rule in the set. If there is a match, the system assigns the corresponding life-cycle classification to the set of time-series data and does not compare the time-series data to other rules in the set of rules. If there is not a match, the system compares the set of time-series data to the next rule in the set.

The system trains a machine learning model to predict product-store life-cycle classifications using the training data sets. Although the machine learning model is trained on training data sets for which classifications have been assigned based on matching features in a set of time-series data with feature-based rules, the machine learning model learns additional relationships and combinations of relationships between features and life-cycle classifications of product-store pairs. For example, the system may assign a label of LLC to a set of time-series data based on the time-series data including a feature A (such as the product having sales in every month of the set of time-series data). The machine learning model may learn, through training, that the presence of features B and C has a greater relationship than the feature A with the product being an LLC product.

One or more embodiments implement a random forest classifier-type machine learning model to predict the life-cycle classification of products. The random forest classifier-type machine learning model is made up of decision trees based on the particular features with which the training data sets were labeled. Decision nodes (e.g., nodes of the decision trees) of the random forest machine learning model represent features and combinations of features. The leaf nodes represent classifications as LLC or SLC. The system trains the random forest classifier model with the training data set. The system then applies a set of time-series data to the trained random forest classifier model to predict whether a product-store pair is a short-life-cycle pair or a long-life-cycle pair.

One or more embodiments include an “inconclusive”-type classifier to classify time-series data sets. The set of features used to label the training data set includes one or more features associated with an “inconclusive” label. For example, the system may assign an “inconclusive” classifier to a set of time-series data if the set of time-series data has a duration shorter than a threshold (c.g., a product has only sold from a particular location for two weeks, and at least four weeks are required to generate an accurate classification). One or more embodiments assign, for purposes of forecasting, an interim “short life cycle” or “long life cycle” classifications to sets of time-series data to which “inconclusive”-type labels have been applied by a trained machine learning model. According to one embodiment, the system applies a majority voting-type process to assign the interim label. The system implements the majority-voting-type process by applying a set of rules including: determining a classification of related products at the same store, determining a classification of related products at different stores, determining a classification of the same product at different stores, and excluding from any majority vote any other interim-type classification labels.

One or more embodiments described in this Specification and/or recited in the claims may not be included in this General Overview section.

### 2. System Architecture

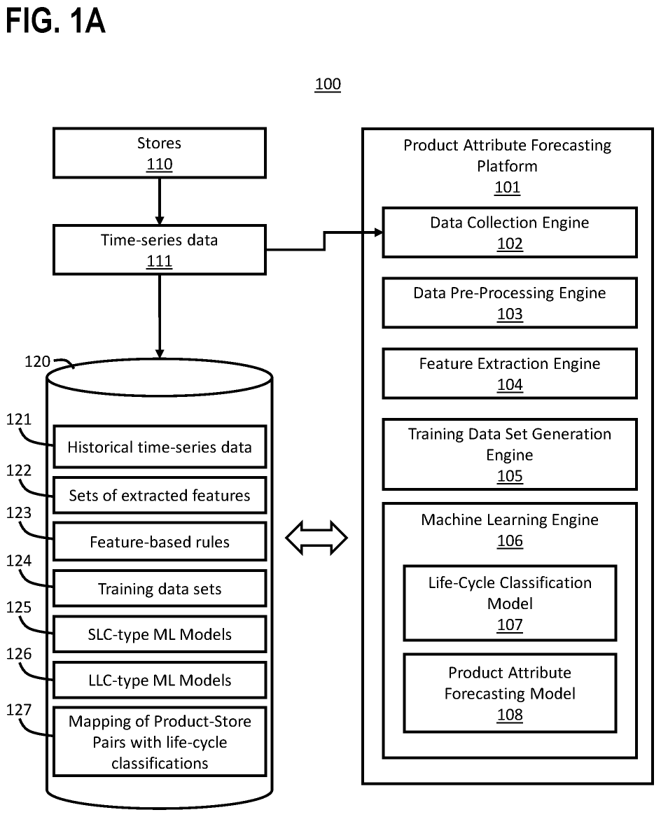

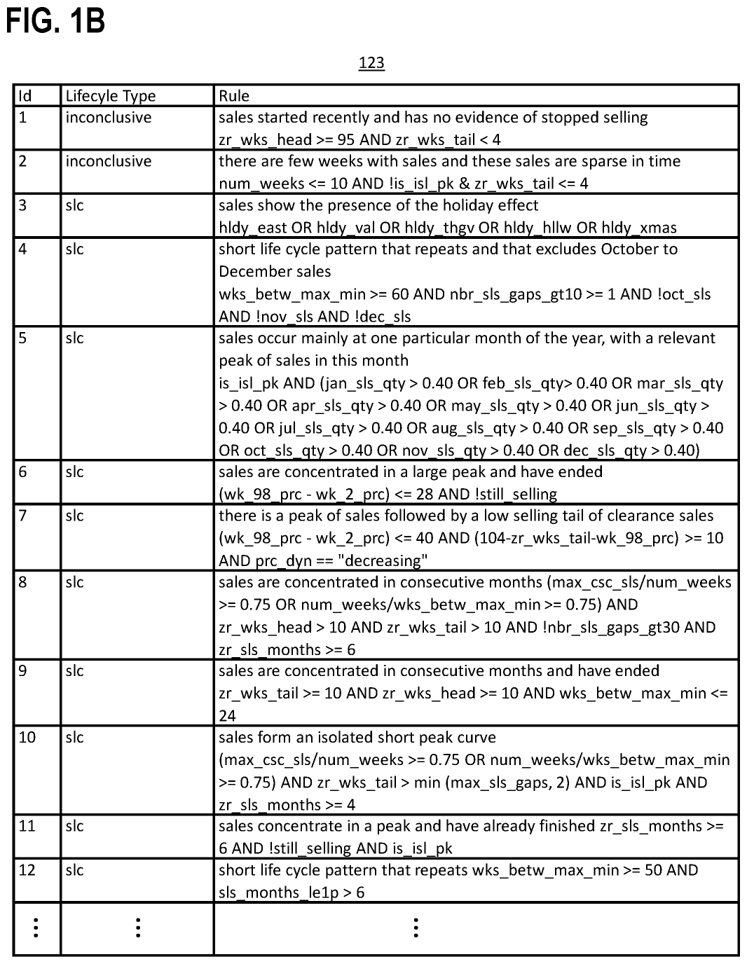

FIG. 1A illustrates a system 100 in accordance with one or more embodiments. As illustrated in FIG. 1A, system 100 includes a product attribute forecasting platform 101. The product attribute forecasting platform 101 obtains time-series data 111 capturing product attributes from stores 110 associated with an entity. Product attributes include: product identifiers, such as stock keeping units (SKUs), prices, inventory data, and sales data. The time-series data 111 also includes metadata describing a location or store associated with the product attributes and a period of time associated with the time-series data 111. The entity may be a retailer, distributor, or other entity that purchases, handles inventory for, and/or sells a product. The product attribute forecasting platform 101 stores data in, and retrieve data from, a data repository 120.

The product attribute forecasting platform 101 includes a data collection engine 102 to retrieve time-series data from one or both of the stores 110 and the data repository 120. For example, the data collection engine 102 obtains historical time-series data 121 from a data repository 120. However, the stores may transmit current time-series data to the data collection engine in real-time, or in defined intervals of time.

A data pre-processing engine 103 performs pre-processing to prepare time-series data for training and/or being applied to a machine learning model. According to one embodiment, the time-series data includes sales data for a set of one or more items as well as related data. Related data may include: pricing and promotion information, merchandise and location hierarchy, and information specifying holidays and special events of-interest. The data pre-processing engine 103 cleans the time-series data by identifying and removing from the time-series data irregularities and disturbance periods. For example, a retailer may identify a three-week period as a period of time in which a storefront was closed due to a natural disaster. The data pre-processing engine 103 removes from the time-series data the sales data for the particular period of time. The data pre-processing engine 103 performs a data imputation process to generate values for the sales data over the period of time corresponding to the disturbance period that was removed from the time-series data. For example, the data pre-processing engine 103 may infer sales data based on one or both of: sales of the same product at the same location at periods of time before and/or after the disturbance period, and sales of the same product at other locations during the disturbance period.

Subsequent to cleaning the time-series data, the data pre-processing engine 103 filters the time-series data down to a specified period of time, such as the most recent 104 weeks of data. If the time-series data includes data for a period of time shorter than the specified period of time, the data pre-processing engine 103 pads the time-series data with values indicating there were no sales of the particular product at the particular store during the specified periods.

A feature extraction engine 104 generates feature sets corresponding to respective sets of time-series data by comparing the time-series data to a set of life-cycle-based features and attributes. For example, one feature corresponds to attributes including whether a particular date has an effect on product sales in the time-series data. The effect may be specified as a variation of 50% or more. For example, the system may determine that the sale of roses increases by more than 50% in the week leading up to Valentine's day in a particular set of time-series data associated with a store in the United States. The system may determine that the sale of gloves is not affected by Valentine's day in another set of time-series data for the same period of time. The events associated with the feature may include, for example, holidays, events associated with sports, with school schedules, with seasons, with political calendars, or with other organizational events.

Another feature corresponds to attributes including whether a set of time-series data shows a peak exceeding a threshold. The peak may be defined, for example, as sales of a particular magnitude, not exceeding a threshold duration of time, and exceeding sales at surrounding time intervals by a threshold amount. For example, the system may specify a peak as sales that reach a value 100% greater than sales at intervals up to two weeks prior to, and up to two weeks subsequent to, the peak value.

Another feature corresponds to attributes including whether an attribute is (a) present one month of the year, and (b) absent the remaining months of the year. For example, the feature may correspond to the presence of sales of a product in the month of January and no sales of the product in the months of February through December.

Another feature corresponds to attributes including whether an attribute is present during one month of the year at a specified level less than a threshold level. For example, the feature may correspond to the presence of sales of a product in the month of January being less than one percent of the total sales of the product during the year.

Another feature corresponds to attributes including a number of time intervals in which an attribute value is less than a threshold level. For example, the feature may correspond to a number of months in the year in which a percentage of sales of a product is less than one percent of the total sales of the product during the year.

Another feature corresponds to attributes including a total number of consecutive intervals of time in which an attribute is not zero in a set of time-series data. For example, the feature may correspond to a total number of weeks in a set of time-series data of 104 weeks at weekly intervals that a product's sales are not zero.

Another feature corresponds to attributes including a change in a particular attribute value. Some attribute values in time series data may change while others remain the same. For example, in one set of time-series data, a product price may remain constant while product sales change. In another set of time-series data, a product price changes and sales change. The feature may be represented as a category specifying whether an attribute is: constant, varying (both increasing and decreasing), increasing only, or decreasing only.

Another feature corresponds to attributes including whether a product is still selling. For example, the feature may correspond to a determination that a product is still selling if it had any sales in the most recent four weeks of time-series intervals.

Another feature corresponds to attributes including a number of time intervals between a zero value for a particular attribute. For example, the feature may correspond to a number of weeks between time intervals showing zero sales for a product.

The feature extraction engine 104 stores a set of features 122 for a given set of time-series data which corresponds to attribute values for a product-store pair over a particular duration of time, in the data repository 120. For example, for a set of sales data for a particular product at a particular store over a period of time of 104 weeks, the system stores a set of feature values indicating which features are present, and in some cases to what extent the features are present, in the set of time-series data. For multiple sets of historical time-series data, the feature extraction engine 104 stores multiple corresponding sets of extracted features 122.

A training-data-set generation engine 105 generates training data sets based on the sets of historical time-series data and corresponding sets of extracted features 122. The training-data-set generation engine 105 compares a set of features associated with a particular set of historical time-series data with a set of feature-based rules 123. The set of feature-based rules 123 specifies particular values for sets of one or more features. A single rule may correspond to one set of values for one feature, or for multiple sets of values for multiple features. Each rule in the set of rules is mapped to a life-cycle classification: long life cycle, short life cycle, or inconclusive. As an example, one rule may map a set of time-series data to an SLC-type life-cycle classification if a value for a particular features exceeds a threshold. Another rule may map a set of time-series data to an LLC-type life-cycle classification if a first value for Feature A is less than a first threshold, and if a second value for Feature B exceeds a second threshold. FIG. 1B illustrates an example of a set of feature-based rules 123 for generating training data sets. The training-data-set generation engine 105 compares a set of extracted features 122 for a particular set of time-series data to the set of feature-based rules 123 in order. Once the training-data-set generation engine 105 detects a match between the set of extracted features 122 for a set of time-series data and a particular rule among the feature-based rules 123, the training-data-set generation engine 105 assigns a corresponding life-cycle classification to the set of time-series data and stops comparing the extracted features 122 for the set of time-series data to additional rules. The order of rules on the hierarchical list of feature-based rules is selected by the system according to observed historical patterns. For example, Rule X for a set of time-series data precedes Rule Y if the presence of features related to Rule X in a set of time-series data is a stronger indicator of a particular life-cycle classification than the presence of features related to Rule Y to its corresponding life-cycle classification.

A machine learning engine 106 trains a life-cycle classification model 107 to classify product-store pairs corresponding to sets of time-series data as long-life-cycle or short-life-cycle types. The machine learning engine 106 trains the life-cycle classification model 107 using the training data sets 124.

According to one embodiment, the life-cycle classification model is a random forest-type classifier model. The random forest-type model includes decision trees comprising nodes. The nodes correspond to features and combinations of features. The leaf nodes correspond to life-cycle classifications: SLC, LLC, and inconclusive. During training, the machine learning engine 106 adjusts weights for nodes of the random forest model.

In some embodiments, the machine learning engine 106 trains machine learning model 107 to perform one or more operations for generating life-cycle classifications for product-store pairs. In addition, the machine learning engine 106 trains machine learning model 108 to perform one or more operations for generating forecasts for attributes associated with the product-store pairs. Training a machine learning model 107 uses training data to generate a function that, given one or more inputs to the machine learning model 107, computes a corresponding output. The output may correspond to a prediction based on prior machine learning. In some embodiments, the output includes a label, classification, and/or categorization assigned to the provided input(s). The machine learning model 107 corresponds to a learned model for performing the desired operation(s) (e.g., labeling, classifying, and/or categorizing inputs). The product attribute forecasting platform 101 uses one machine learning model 107 to classify product-store pairs as corresponding to particular life-cycle types. Based on the classification, the machine learning engine 106 selects from among SLC-type machine learning models 125 and LLC-type machine learning models 126 to generate a forecasting model 108 for a particular product-store pair.

In some embodiments, the machine learning engine 106 may use supervised learning, semi-supervised learning, unsupervised learning, reinforcement learning, and/or another training method or combination thereof. In supervised learning, labeled training data includes input/output pairs in which each input is labeled with a desired output (e.g., a label, classification, and/or categorization), also referred to as a supervisory signal. In semi-supervised learning, some inputs are associated with supervisory signals and other inputs are not associated with supervisory signals. In unsupervised learning, the training data does not include supervisory signals. Reinforcement learning uses a feedback system in which the machine learning engine 106 receives positive and/or negative reinforcement in the process of attempting to solve a particular problem (e.g., to classify time-series data corresponding to product-store pairs according to life-cycle types). In some embodiments, the machine learning engine 106 initially uses supervised learning to train the machine learning model 107 and then uses unsupervised learning to update the machine learning model 107 on an ongoing basis.

In some embodiments, a machine learning engine 106 may use many different techniques to label, classify, and/or categorize inputs. A machine learning engine 106 may transform inputs into feature vectors that describe one or more properties (“features”) of the inputs. The machine learning engine 106 may label, classify, and/or categorize the inputs based on the feature vectors. Alternatively, or additionally, a machine learning engine 106 may use clustering (also referred to as cluster analysis) to identify commonalities in the inputs. The machine learning engine 106 may group (i.e., cluster) the inputs based on those commonalities. The machine learning engine 106 may use hierarchical clustering, k-means clustering, and/or another clustering method or combination thereof. In some embodiments, a machine learning engine 106 includes an artificial neural network. An artificial neural network includes multiple nodes (also referred to as artificial neurons) and edges between nodes. Edges may be associated with corresponding weights that represent the strengths of connections between nodes, which the machine learning engine 106 adjusts as machine learning proceeds. Alternatively, or additionally, a machine learning engine 106 may include a support vector machine. A support vector machine represents inputs as vectors. The machine learning engine 106 may label, classify, and/or categorizes inputs based on the vectors. The coordinates of the vectors and corresponding boundaries between different hyperplanes may be adjusted as machine learning proceeds. Alternatively, or additionally, the machine learning engine 106 may use a naïve Bayes classifier to label, classify, and/or categorize inputs. Alternatively, or additionally, given a particular input, a machine learning model may apply a decision tree, such as a random forest model, to predict an output for the given input. Alternatively, or additionally, a machine learning engine 106 may apply fuzzy logic in situations where labeling, classifying, and/or categorizing an input among a fixed set of mutually exclusive options is impossible or impractical. The aforementioned machine learning model 107 and techniques are discussed for exemplary purposes only and should not be construed as limiting one or more embodiments.

In some embodiments, as a machine learning engine 106 applies different inputs to a machine learning model 107, the corresponding outputs are not always accurate. As an example, the machine learning engine 106 may use supervised learning to train a machine learning model 107. After training the machine learning model 107, if a subsequent input is identical to an input that was included in labeled training data and the output is identical to the supervisory signal in the training data, then output is certain to be accurate. If an input is different from inputs that were included in labeled training data, then the machine learning engine 106 may generate a corresponding output that is inaccurate or of uncertain accuracy. In addition to producing a particular output for a given input, the machine learning engine 106 may be configured to produce an indicator representing a confidence (or lack thereof) in the accuracy of the output. A confidence indicator may include a numeric score, a Boolean value, and/or any other kind of indicator that corresponds to a confidence (or lack thereof) in the accuracy of the output.

The product attribute forecasting platform 101 obtains time-series data 111 from one or more stores 110. The time-series data 111 includes multiple sets of time-series data corresponding to multiple different product-store pairs (e.g., each product-store pair is a unique combination of a product and a store). The product attribute forecasting platform 101 applies the life-cycle classification machine learning model 107 to the time-series data 111 to generate a mapping of (a) product-store pairs to (b) life-cycle classifications. Based on the mapping for a particular product-store pair to a particular life-cycle type, the product attribute forecasting platform 101 applies the machine learning model (e.g., SLC-type model 125 or LLC-type model 126) corresponding to the particular product-store pair to sets of time-series data 111 corresponding to the particular product-store pair to generate forecasts for the product-store pair.

In one or more embodiments, the system 100 may include more or fewer components than the components illustrated in FIG. 1A. The components illustrated in FIG. 1A may be local to or remote from each other. The components illustrated in FIG. 1A may be implemented in software and/or hardware. Each component may be distributed over multiple applications and/or machines. Multiple components may be combined into one application and/or machine. Operations described with respect to one component may instead be performed by another component.

Additional embodiments and/or examples relating to computer networks are described below in Section 6, titled “Computer Networks and Cloud Networks.”

In one or more embodiments, a data repository 120 is any type of storage unit and/or device (e.g., a file system, database, collection of tables, or any other storage mechanism) for storing data. Further, a data repository 120 may include multiple different storage units and/or devices. The multiple different storage units and/or devices may or may not be of the same type or located at the same physical site. Further, a data repository 120 may be implemented or may execute on the same computing system as the product attribute forecasting platform 101. Alternatively, or additionally, a data repository 120 may be implemented or executed on a computing system separate from the product attribute forecasting platform 101. A data repository 120 may be communicatively coupled to the product attribute forecasting platform 101 via a direct connection or via a network.

Information describing sets of extracted features 122, feature-based rules 123, training data sets 124, models 125 and 126, and mappings 127 may be implemented across any of components within the system 100. However, this information is illustrated within the data repository 120 for purposes of clarity and explanation.

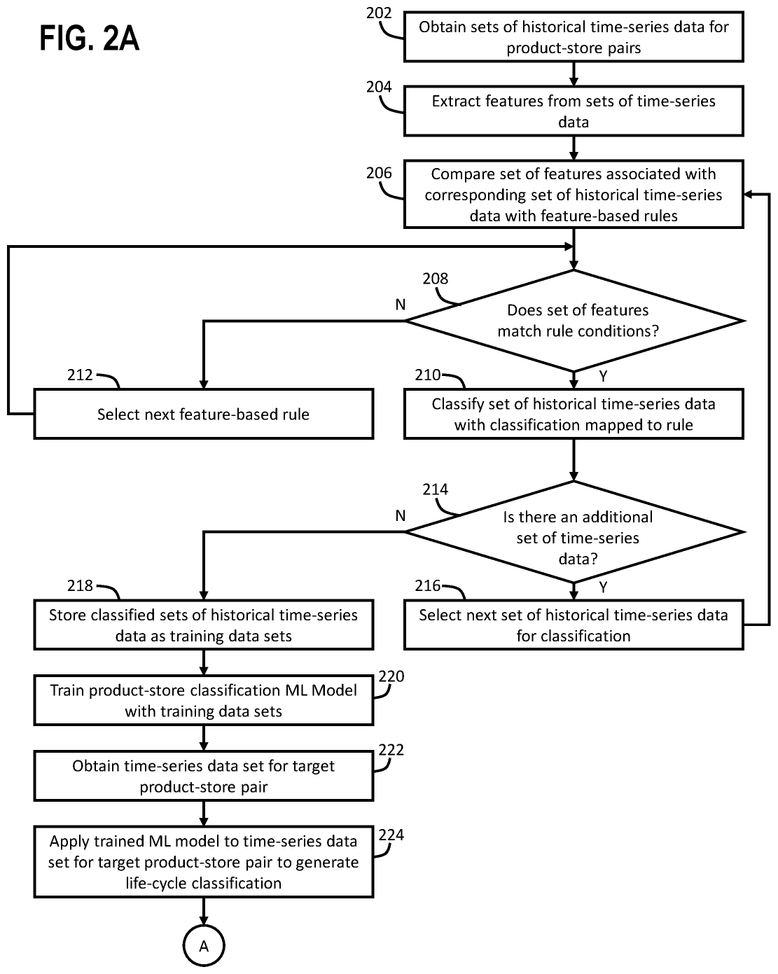

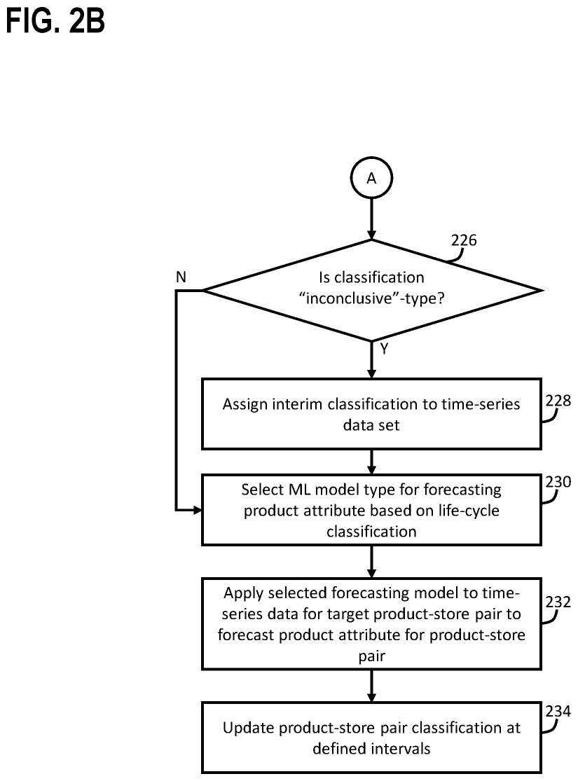

In one or more embodiments, a product attribute forecasting platform 101 refers to hardware and/or software configured to perform operations described herein for generating training data sets, training a machine learning model to classify product-store pairs, and applying machine learning models to classify time-series data and to generate forecasts based on time-series data. Examples of operations for training a machine learning model to generate life-cycle classifications for product-store pairs are described below with reference to FIGS. 2A and 2B.

In an embodiment, the product attribute forecasting platform 101 is implemented on one or more digital devices. The term “digital device” generally refers to any hardware device that includes a processor. A digital device may refer to a physical device executing an application or a virtual machine. Examples of digital devices include a computer, a tablet, a laptop, a desktop, a netbook, a server, a web server, a network policy server, a proxy server, a generic machine, a function-specific hardware device, a hardware router, a hardware switch, a hardware firewall, a hardware network address translator (NAT), a hardware load balancer, a mainframe, a television, a content receiver, a set-top box, a printer, a mobile handset, a smartphone, a personal digital assistant (“PDA”), a wireless receiver and/or transmitter, a base station, a communication management device, a router, a switch, a controller, an access point, and/or a client device.

### 3. Training Machine Learning Model to Classify Product-Store Pairs According to Life Cycles

FIGS. 2A and 2B illustrate an example set of operations for training a machine learning model to classify product-store pairs according to life cycles in accordance with one or more embodiments. One or more operations illustrated in FIGS. 2A and 2B may be modified, rearranged, or omitted all together. Accordingly, the particular sequence of operations illustrated in FIGS. 2A and 2B should not be construed as limiting the scope of one or more embodiments.

A system obtains sets of historical time-series data for product-store pairs (Operation 202). The sets of historical time-series data include values for attributes of a product-store pair over time. For example, the time-series data may include values for: a price of a product associated with a particular SKU sold from a particular store over time, a level of inventory associated with a particular SKU at a particular store, and the number of units sold for a particular product at a particular store.

The system extracts features from the sets of historical time-series data by comparing characteristics of the sets of historical time-series data to particular feature attributes to determine whether the features are present in the historical time-series data (Operation 204). Examples of features include: attribute peaks in the time-series data, seasonal trends in the time-series data, an increase in an attribute surrounding particular events, such as holidays, a value for an attribute that exceeds a threshold for the entire span of the time-series data, and a measure of time intervals between a particular value (such as a value of zero) for a particular attribute. For example, one feature may correspond to a value representing a number of peaks in a set of time-series data spanning two years, where the feature defines peaks as a quantity of sales exceeding a threshold and varying from surrounding sales beyond another threshold. If a set of time-series data shows three sales peaks, where sales of a product exceeded 100% of product sales before and after the peak, the system stores a value “3” in a feature set associated with the time-series data. As another example, another feature in the feature set indicates how many months in a set of data spanning two years sales of a product were “0.” If a set of time-series data shows no months without sales, the system stores a value of “0” for the particular feature in the feature set associated with the time-series data. Alternatively, if the set of time-series data shows one month without sales, the system stores a value of “1” for the particular feature in the feature set associated with the time-series data.

The system generates sets of training data by comparing values for a set of features extracted from a particular set of time-series data to a set of feature-based rules (Operation 206). Each feature-based rule is mapped to a particular life-cycle classification: long life cycle (LLC), short life cycle (SLC), or “inconclusive.” For example, a particular set of time-series data may include features A, B, D, and F with corresponding values of 1, 0, 1, and 4. One rule may assign a classification “inconclusive” to a product-store pair associated with a set of time-series data if the set of time-series data include feature D with a value less than 4. Another rule may assign a classification “SLC” to a product-store pair associated with a set of time-series data if the set of time-series data includes features with values A=1 and B<2. According to one embodiment, the feature-based rules include a set of hierarchical feature-based rules. The system compares features associated with a set of time-series data to the set of hierarchical feature-based rules in a particular sequence. Once the system determines that the features associated with the set of time-series data match a particular feature-based rule, then it assigns a classification mapped to the feature-based rule to the product-store pair associated with the set of time-series data. The system refrains from comparing the set of features associated with the set of time-series data to additional rules in the set of hierarchical feature-based rules.

If the system determines that the set of features corresponding to a set of time-series data matches a set of conditions for a particular rule (Operation 208, Yes), the system assigns to the set of time-series data the classification mapped to the feature-based rule (Operation 210). If the system determines that the set of features corresponding to a set of time-series data does not match a set of conditions for a particular rule (Operation 208, No), the system selects the next feature-based rule in sequence for comparison with the set of features associated with the set of time-series data (Operation 212).

For example, one rule may be mapped to a classification, “inconclusive.” Another rule may be mapped to a classification, “SLC.” Another rule may be mapped to a classification, “LLC.” If the features of the time-series data match conditions for the “inconclusive”-type rule, and if the “inconclusive”-type rule precedes the “SLC”-type rule and the “LLC”-type rule in a sequence of rules, then the system assigns to the set of time-series data the classification “inconclusive.” Alternatively, if the features associated with a set of time-series data do not match the “inconclusive”-type rule, if the “SLC”-type rule is the next rule in the sequence of rules, and if the features of the time-series data match the conditions of the “SLC”-type rule, then the system assigns to the set of time-series data the “SLC”-type classification. Alternatively, if the features associated with a set of time-series data do not match the “SLC”-type rule, if the “LLC”-type rule is the next rule in the sequence of rules, and if the features of the time-series data match the conditions of the “LLC”-type rule, then the system assigns to the set of time-series data the “LLC”-type classification.

Subsequent to assigning a classification to a set of time-series data corresponding to a particular product-store pair, the system determines whether there is another set of time-series data and corresponding set of features for comparison with the feature-based rules (Operation 214). For example, the system may assign classifications to sets of time-series data associated with product-store pairs until a threshold number of sets of time-series data, such as 10,000 sets of time-series data, have been classified. The sets of time-series data include different product-store pairs, including: sets of time series data for the same products and different stores, sets of time-series data for different products and the same store, and sets of time-series data for different products and different stores.

If the system determines that there are additional sets of time-series data for classification, the system selects the next set of time-series data for comparison with the feature-based rules (Operation 216). Conversely, if the system determines that there are not additional sets of time-series data for classification, such as if a threshold number of sets of time-series data have been classified, then the system stores the classified sets of historical time-series data as training data sets for training a machine learning model (Operation 218). According to one embodiment, the system selects time-series data sets with classifications “inconclusive,” “SLC,” and “LLC” for inclusion in the training data sets. According to an alternative embodiment, the system selects time-series data sets only with classifications “SLC” and “LLC” for inclusion in the training data sets, while excluding from the training data sets time-series data classified as “inconclusive.” In this embodiment, when a set of time-series data that has features corresponding to an “inconclusive”-type rule is received by a trained machine learning model, which has not been trained to generate an “inconclusive”-type classification, the machine learning model generates a classification “SLC” or “LLC” that most closely corresponds to the input time-series data.

The system trains a machine learning model using the training data sets to generate a life-cycle type classification for product-store pairs corresponding to sets of time-series data (Operation 220). According to one example embodiment, the machine learning model is a random forest-type model. Although the model is trained with sets of training data generated using a set of feature-based rules, the machine learning model learns additional relationships among sets of features and corresponding life-cycle classifications for classifying sets of time-series data.

According to one embodiment, a machine learning algorithm analyzes training data sets to train neurons of a neural network with particular weights and offsets to associate particular product-store pairs with particular life-cycle classifications. In some embodiments, the system iteratively applies the machine learning algorithm to a set of input data to generate an output set of labels, compares the generated labels to pre-generated labels associated with the input data, adjusts weights and offsets of the algorithm based on an error, and applies the algorithm to another set of input data. In some cases, the system may generate and train a candidate recurrent neural network model, such as a long short-term memory (LSTM) model. With recurrent neural networks, one or more network nodes or “cells” may include a memory. A memory allows individual nodes in the neural network to capture dependencies based on the order in which feature vectors are fed through the model. The weights applied to a feature vector representing characteristics of a set of time-series data may depend on its position within a sequence of feature vector representations. Thus, the nodes may have a memory to remember relevant temporal dependencies between different sets of time-series data. For example, a set of time-series data in isolation may have a first set of weights applied by nodes as a function of the respective feature vector. However, if the set of time-series data is immediately preceded by another set of time-series data associated with a corresponding life-cycle classification, then a different set of weights may be applied by one or more nodes based on the memory of the preceding set of time-series data. In this case, a life-cycle classification assigned to the second set of time-series data may be affected by the first set of time-series data. Additionally, or alternatively, the system may generate and train other candidate models, such as support vector machines, decision trees, Bayes classifiers, and/or fuzzy logic models, as previously described.

In some embodiments, the system compares the labels estimated through the one or more iterations of the machine learning model algorithm with observed labels to determine an estimation error. The system may perform this comparison for a test set of examples, which may be a subset of examples in the training dataset that were not used to generate and fit the candidate models. The total estimation error for a particular iteration of the machine learning algorithm may be computed as a function of the magnitude of the difference and/or the number of examples for which the estimated label was wrongly predicted.

In some embodiments, the system determines whether to adjust the weights and/or other model parameters based on the estimation error. Adjustments may be made until a candidate model that minimizes the estimation error or otherwise achieves a threshold level of estimation error is identified. Upon adjusting weights and/or other parameters of the machine learning algorithm, the system selects a next set of training data to apply to the machine learning algorithm.

In some embodiments, the system selects machine learning model parameters based on the estimation error meeting a threshold accuracy level. For example, the system may select a set of parameter values for a machine learning model based on determining that the trained model has an accuracy level for predicting labels for life-cycle classifications of at least 98%.

In some embodiments, the system trains a neural network using backpropagation. Backpropagation is a process of updating cell states in the neural network based on gradients determined as a function of the estimation error. With backpropagation, nodes are assigned a fraction of the estimated error based on the contribution to the output and adjusted based on the fraction. In recurrent neural networks, time is also factored into the backpropagation process. As previously mentioned, a given example may include a sequence of related feature vectors. Each feature vector may be processed as a separate discrete instance of time. For instance, an example may include feature vectors c₁, c₂, and c₃ corresponding to times t, t+1, and t+2, respectively. Backpropagation through time may perform adjustments through gradient descent starting at time t1+2 and moving backward in time to t+1 and then to t. Further, the backpropagation process may adjust the memory parameters of a cell such that a cell remembers contributions from previous feature vectors in the sequence of feature vectors. For example, a cell computing a contribution for c₃ may have a memory of the contribution of c₂, which has a memory of c₁. The memory may serve as a feedback connection such that the output of a cell at one time (c.g., t) is used as an input to the next time in the sequence (e.g., t+1). The gradient descent techniques may account for these feedback connections such that the contribution of one feature vector to a cell's output may affect the contribution of the next feature vector in the cell's output. Thus, the contribution of c₁ may affect the contribution of c₂, etc.

Additionally, or alternatively, the system may train other types of machine learning models. For example, the system may adjust the boundaries of a hyperplane in a support vector machine or node weights within a decision tree model to minimize estimation error. Once trained, the machine learning model may be used to estimate labels for new examples of time-series data corresponding to product-store pairs.

In embodiments in which the machine learning algorithm is a supervised machine learning algorithm, the system may optionally obtain feedback on the various aspects of the analysis described above. For example, the feedback may affirm or revise labels generated by the machine learning model. The machine learning model may indicate that a particular set of time-series data associated with a particular product-store pair is associated with a label “SLC”, instead of the machine-generated label “inconclusive.” Based on the feedback, the machine learning training set may be updated, thereby improving its analytical accuracy. Once updated, the system may further train the machine learning model by optionally applying the model to additional training data sets.

Upon training the machine-learning model, the system obtains a set of target time-series data for a target product-store pair (Operation 222). The set of target time-series data may be a recently-generated set of data for forecasting attributes for a particular product-store pair. For example, the set of target time-series data may include sales data for a product-store pair over the previous 104 weeks to generate a forecast for the sales of the product-store pair over the next three months.

The system applies the trained machine-learning model to the target time-series data to generate a life-cycle classification for the set of target time-series data and the corresponding product-store pair (Operation 224). According to one embodiment, the machine learning model classifies a set of time series data as either corresponding to a short-life-cycle product-store pair or to a long-life-cycle product-store pair. According to another embodiment, the machine learning model may classify the time-series data in a third category: “inconclusive.” For example, a characteristic of an inconclusive-type set of time-series data may include a set of time-series data having fewer than four weeks of sales data.

According to one or more embodiments, the system determines if the classification assigned to the set of time-series data by the machine learning model is “inconclusive.” (Operation 226). If the classification type is “inconclusive,” the system assigns to the time-series data an interim classification of SLC or LLC for purposes of attribute forecasting (Operation 228). According to one or more embodiments, the system performs a “majority voting” method to assign the interim classification to the set of time-series data and the corresponding product-store pair. The majority voting method includes comparing the characteristics of the particular product-store pair associated with the “inconclusive”-type classification to other product-store pairs. The system may perform the comparison in a particular sequence.

For example, a majority-voting sequence may include, in sequence: (1) determining a majority of classifications for a set of products in a same subclass (e.g., the same type of product), the same store, and the same price zone, (2) determining a majority of classifications for a set of products in the same subclass and the same price zone that are not interim classifications, (3) determining a majority of classifications for a set of products in the same subclass that are not interim classifications, and (4) if none of (1)-(3) results in a majority value, assign a predefined default classification.

The system selects a particular type of forecasting model for generating a forecast for a product-store pair based on the life-cycle classification assigned to the time-series data corresponding to the product-store pair (Operation 230). For a set of time-series data classified as a short-life-cycle type, the system selects a forecasting model suited to forecasting attributes of a product-store pair with a short life cycle. For a set of time-series data classified as a long-life-cycle type, the system selects a forecasting model suited to forecasting attributes of a product-store pair with a long life cycle.

The system applies the selected type of forecasting model to the time-series data to generate a forecast of attributes for a product-store pair (Operation 232). For example, the system may apply a forecasting model to a set of time-series data corresponding to a short-life-cycle product-store pair to predict a price of the product at a particular store over the next three months. As another example, the system may apply a forecasting model to a set of time-series data corresponding to a long-life-cycle product-store pair to predict inventory levels of a product at a particular store over the following year.

The system updates the product-store pair classification at predefined intervals of time (Operation 234). The predefined intervals of time may vary for product-store pairs according to their classification. For example, a system may update classifications for “inconclusive”-type product-store pairs every week. The system may update classifications for short-life-cycle type product-store pairs every month. The system may update classifications for long-life-cycle type product-store pairs every three months.

### 4. Example Embodiment

A detailed example is described below for purposes of clarity. Components and/or operations described below should be understood as one specific example which may not be applicable to certain embodiments. Accordingly, components and/or operations described below should not be construed as limiting the scope of any of the claims.

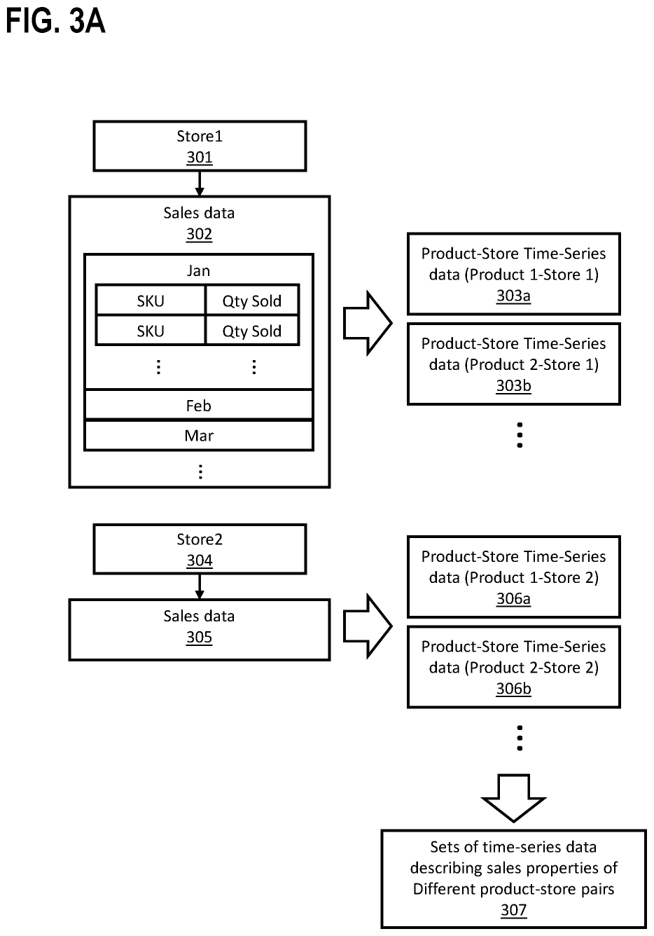

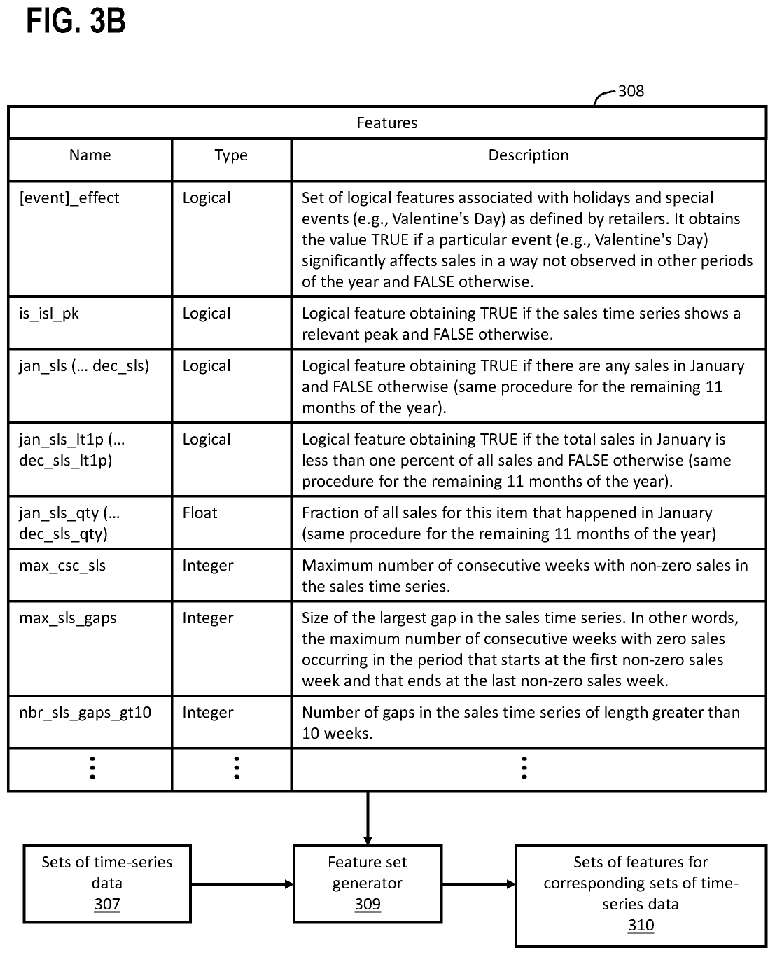

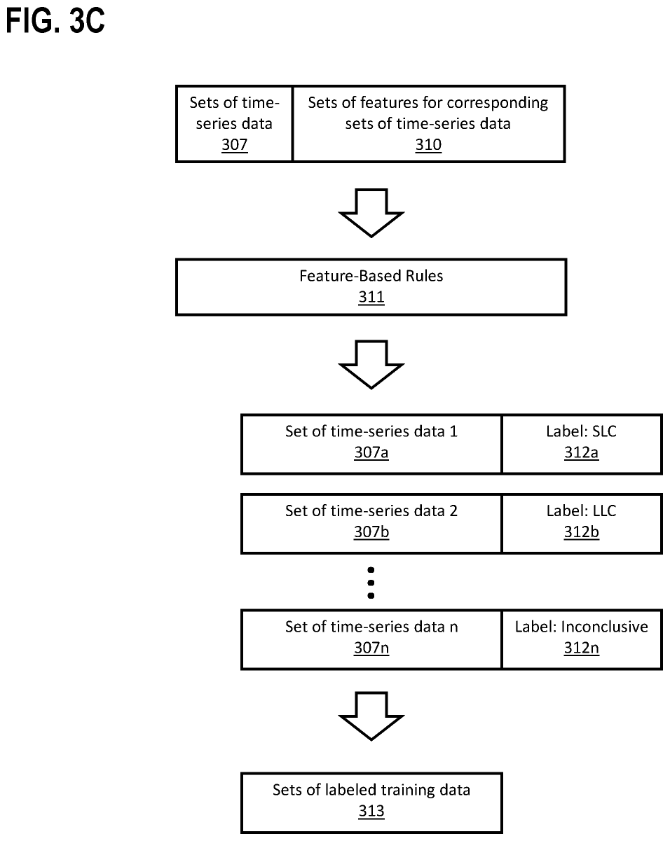

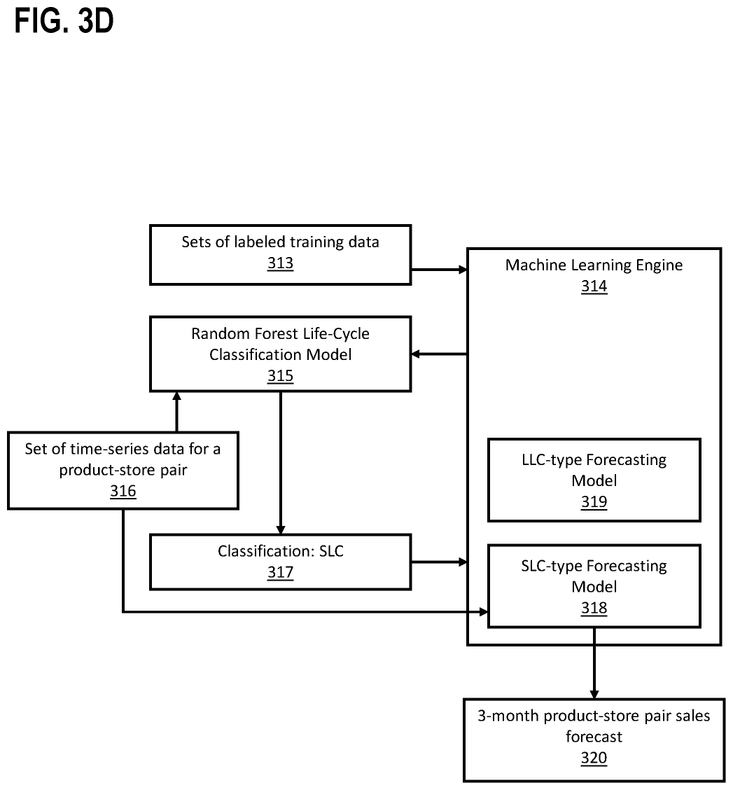

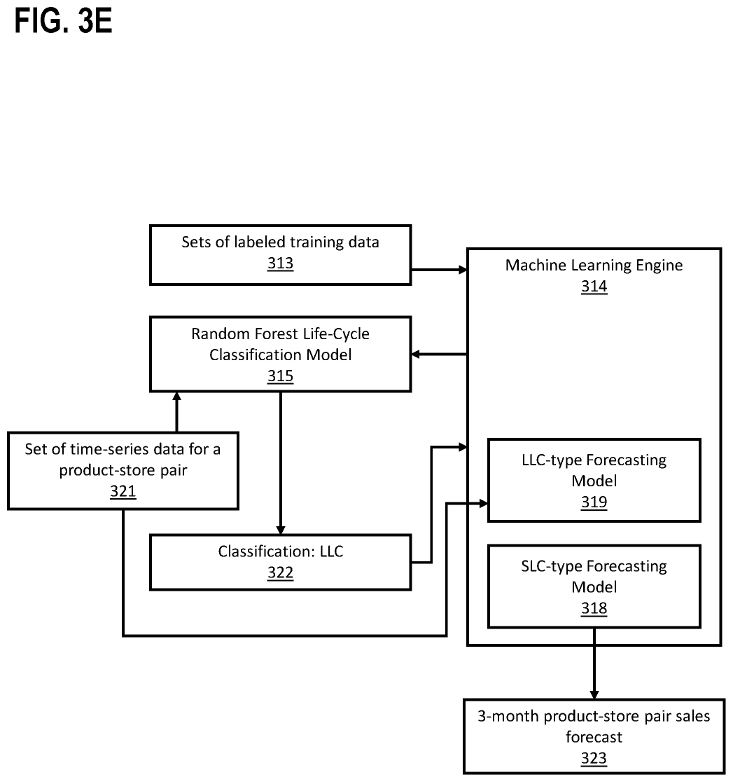

FIGS. 3A-3E illustrate an example set of operations for training a random forest type machine learning model to classify product-store pairs according to life cycles in accordance with one or more embodiments.

Stores 301 and 304 generate sets of sales data 302 and 305, respectively. For example, an enterprise may monitor transactions involving SKUs at the stores 301 and 304 to compile the sales data 302 and 305. Sales data 302 includes, for each month (January-December), the quantities for each SKU involved in a sales transaction. A system, such as a product attribute forecasting platform 101 described in FIG. 1A, obtains the sales data 302 and 305 and generates sets of product-store time-series data for product-store pairs. For example, for any products sold at store 1 (301), the system generates a set of time-series data. The sets of time-series data include a set 303a for Product 1 sold at Store 1 and a set 303b for Product 2 sold at Store 1 during a time period from January-December. According to one example, the time-series data may span 52 weeks. According to an alternative example, the time-series data may span 104 weeks, or any other desired time span. The system generates time-series data 306a and 306b for products sold from store 2 (304) during the time period (e.g., January, year 1-December, year 2).

Referring to FIG. 3B, a feature set generator 309 generates, for each set of time-series data 307, a set of features 310. The feature set generator 309 identifies attributes of features 308 to the sets of time-series data 307 to generate the corresponding sets of features 310 for each set of time-series data 307. Examples of features include: attribute peaks in the time-series data, seasonal trends in the time-series data, an increase in an attribute surrounding particular events, such as holidays, a value for an attribute that exceeds a threshold for the entire span of the time-series data, and a measure of time intervals between a particular value (such as a value of zero) for a particular attribute. For example, one feature may correspond to a value representing a number of peaks in a set of time-series data spanning two years, where the feature defines peaks as a quantity of sales exceeding a threshold and varying from surrounding sales beyond another threshold. If a set of time-series data shows three sales peaks, where sales of a product exceeded 100% of product sales before and after the peak, the system stores a value “3” in a feature set associated with the time-series data. As another example, another feature in the feature set indicates how many months in a set of data spanning two years sales of a product were zero. If a set of time-series data shows no months without sales, the system stores a value of “0” for the particular feature in the feature set associated with the time-series data. Alternatively, if the set of time-series data shows one month without sales, the system stores a value of “1” for the particular feature in the feature set associated with the time-series data.

Referring to FIG. 3C, the system generates sets of labeled training data 313 by comparing values for a set of features 310 extracted from a particular set of time-series data 307 to a set of hierarchical feature-based rules. The set of feature-based rules is hierarchical, because the system first compares the set of features to a first rule to determine whether the features 310 match conditions in the rule. The system compares features associated with a set of time-series data to the set of hierarchical feature-based rules in a particular sequence. Once the system determines that the features associated with the set of time-series data match a particular feature-based rule, it assigns a classification mapped to the feature-based rule to the product-store pair associated with the set of time-series data. The system refrains from comparing the set of features associated with the set of time-series data to additional rules in the set of hierarchical feature-based rules. An example set of hierarchical feature-based rules is illustrated in FIG. 1B. Each feature-based rule is mapped to a particular life-cycle classification: long life cycle (LLC), short life cycle (SLC), or “inconclusive.” For example, a particular set of time-series data may include features A, B, D, and F with corresponding values of 1, 0, 1, and 4. One rule may assign a classification “inconclusive” to a product-store pair associated with a set of time-series data if the set of time-series data include feature D with a value less than 4. Another rule may assign a classification “SLC” to a product-store pair associated with a set of time-series data if the set of time-series data includes features with values A=1 and B<2.

In the example illustrated in FIG. 3C, the system compares features 310 extracted from time-series data 307 for different product-store pairs to the hierarchical feature-based rules 311 to generate labels 312a, 312b, . . . 312n (e.g., SLC, LLC, and “inconclusive”) for the sets of time-series data 307a, 307b, . . . 307n.

Referring to FIG. 3D, a machine learning engine 314 trains a random forest-type machine learning model 315 using the sets of labeled training data 313.

A user or system may select characteristics of the random forest-type model 315 to be trained. For example, a user or system may select a subset of features 308 that are most likely to have the greatest impact on the life-cycle classification of a set of time-series data based on previously-performed product-store analyses. According to one example embodiment, a user or system may apply a threshold number to the hierarchical rules-based labeling process. For example, the system may select for inclusion in the random forest model 315 the twenty most-applied rules among the hierarchical feature-based rules 311. According to another example embodiment, a system may include feature importance ranking as an operation that may be performed by the random forest model 315. For example, prior to training the model, the system may identify in the sets of time-series data the subset of features that have the greatest influence on the model. According to yet another example embodiment, a system may perform recursive feature elimination (RFE) to identify the most important features for inclusion in a random forest model 315. The system iteratively trains random forest models, with each iteration removing the least-important feature. A user or system may specify a number of features to be included in the final trained model 315. The system iteratively applies the RFE process until the specified number of features remains in the final trained model 315.

In addition to selecting features for inclusion in the random forest model 315, a user or system selects a number and depth of trees for inclusion in the model 315. According to one example embodiment, the system generates an initial model with a specified number and depth of trees and adjusts one or both of the number and depth based on performance of the model 315. For example, the system may generate a model with 100 trees and a depth of 5 levels per tree. The system tunes the number and depth of trees within a predefined range (such as between 100-500 trees and between 5-20 levels per tree) based on performance of the model. For example, after training the model with a training data set, the system may apply the validation data set and determine that the model has an accuracy below a threshold, such as below 90%. Accordingly, the system may increase one or both of the number and depth of trees in the model, and re-train the model with the increased number and/or depth of trees. Additional examples of methods for selecting a number and depth of trees for the model include a grid search and cross-validation method and an early stopping method. An early-stopping method involves monitoring the model's performance on a validation set during training and stopping the training process when the performance stops improving.

Upon training the random forest model 315, the system obtains a set of time-series data 316 for a particular product-store pair. The time-series data may be a recently-generated set of data. For example, the set of time-series data may include sales data for a product-store pair over the most-recent 104 weeks. The system provides the time-series data 316 as input data to the random forest model 315 to generate a life-cycle classification 317 for the time-series data 316.

In the example illustrated in FIG. 3D, the random forest model 315 generates a classification 317 for the time-series data 316 as corresponding to a “short life cycle” (SLC) product-store pair. However, if the system determines a classification assigned to a set of time-series data by the random forest model 315 is “inconclusive.” the system assigns to the time-series data an interim classification of SLC or LLC to perform attribute forecasting for the time-series data.

The system applies the SLC-type forecasting model 318 to the time-series data to generate a three-month forecast 320 of sales of the product corresponding to the time-series data 316 at the store corresponding to the time-series data 316.

In the example illustrated in FIG. 3E, the system obtains another set of time-series data 321 for a different product-store pair than the pair corresponding to the time-series data 316. The random forest model 315 generates a classification 322 for the time-series data 321 as corresponding to a “long life cycle” (LLC) product-store pair. The system applies the LLC-type forecasting model 319 to the time-series data 321 to generate a three-month forecast 323 of sales of the product corresponding to the time-series data 321 at the store corresponding to the time-series data 321.

### 5. Practical Applications, Advantages, and Improvements

One or more embodiments described herein provide retailers and other entities with systems and methods to perform demand forecasting for particular product-store pairs, rather than for merely classes or categories of products across groupings of stores. The systems and methods described herein apply a machine learning model, such as a random forest model, to provide granular, product-store pair-level forecasts (e.g., a forecast for a particular product at a particular sales location) without the need for human-intensive analysis of sales trends for the particular product at the particular sales location. Generating a set of training data using a hierarchical, rule-based classification, and subsequently training a machine learning model to predict product-store life-cycle classifications on the rule-based categorized training data provides benefits of (a) reducing human-intensive analysis of training data typically required to generate labeled training data, while also (b) allowing for a machine learning model to use the rule-based labeled training data to perform non-rule-based classifications of previously-unclassified data. In other words, even though a product-store life cycle classification model is trained on a set of training data that is generated by a rule-based process, the trained machine learning model identifies relationships among product-store time-series data and life-cycle classifications that may result in a different classification for a set of time-series data than would result from the rule-based classification which was used to train the model. The systems and methods described herein identify how sales patterns for different products differ between different locations and from other products at the same location.

### 6. Computer Networks and Cloud Networks

In one or more embodiments, a computer network provides connectivity among a set of nodes. The nodes may be local to and/or remote from each other. The nodes are connected by a set of links. Examples of links include a coaxial cable, an unshielded twisted cable, a copper cable, an optical fiber, and a virtual link.

A subset of nodes implements the computer network. Examples of such nodes include a switch, a router, a firewall, and a network address translator (NAT). Another subset of nodes uses the computer network. Such nodes (also referred to as “hosts”) may execute a client process and/or a server process. A client process makes a request for a computing service (such as, execution of a particular application, and/or storage of a particular amount of data). A server process responds by executing the requested service and/or returning corresponding data.

A computer network may be a physical network, including physical nodes connected by physical links. A physical node is any digital device. A physical node may be a function-specific hardware device, such as a hardware switch, a hardware router, a hardware firewall, and a hardware NAT. Additionally or alternatively, a physical node may be a generic machine that is configured to execute various virtual machines and/or applications performing respective functions. A physical link is a physical medium connecting two or more physical nodes. Examples of links include a coaxial cable, an unshielded twisted cable, a copper cable, and an optical fiber.

A computer network may be an overlay network. An overlay network is a logical network implemented on top of another network (such as, a physical network). Each node in an overlay network corresponds to a respective node in the underlying network. Hence, each node in an overlay network is associated with both an overlay address (to address the overlay node) and an underlay address (to address the underlay node that implements the overlay node). An overlay node may be a digital device and/or a software process (such as, a virtual machine, an application instance, or a thread) A link that connects overlay nodes is implemented as a tunnel through the underlying network. The overlay nodes at either end of the tunnel treat the underlying multi-hop path between them as a single logical link. Tunneling is performed through encapsulation and decapsulation.

In an embodiment, a client may be local to and/or remote from a computer network. The client may access the computer network over other computer networks, such as a private network or the Internet. The client may communicate requests to the computer network using a communications protocol, such as Hypertext Transfer Protocol (HTTP). The requests are communicated through an interface, such as a client interface (such as a web browser), a program interface, or an application programming interface (API).

In an embodiment, a computer network provides connectivity between clients and network resources. Network resources include hardware and/or software configured to execute server processes. Examples of network resources include a processor, a data storage, a virtual machine, a container, and/or a software application. Network resources are shared amongst multiple clients. Clients request computing services from a computer network independently of each other. Network resources are dynamically assigned to the requests and/or clients on an on-demand basis. Network resources assigned to each request and/or client may be scaled up or down based on, for example, (a) the computing services requested by a particular client, (b) the aggregated computing services requested by a particular tenant, and/or (c) the aggregated computing services requested of the computer network. Such a computer network may be referred to as a “cloud network.”

In an embodiment, a service provider provides a cloud network to one or more end users. Various service models may be implemented by the cloud network, including but not limited to Software-as-a-Service (SaaS), Platform-as-a-Service (PaaS), and Infrastructure-as-a-Service (IaaS). In SaaS, a service provider provides end users the capability to use the service provider's applications, which are executing on the network resources. In PaaS, the service provider provides end users the capability to deploy custom applications onto the network resources. The custom applications may be created using programming languages, libraries, services, and tools supported by the service provider. In IaaS, the service provider provides end users the capability to provision processing, storage, networks, and other fundamental computing resources provided by the network resources. Any arbitrary applications, including an operating system, may be deployed on the network resources.

In an embodiment, various deployment models may be implemented by a computer network, including but not limited to a private cloud, a public cloud, and a hybrid cloud. In a private cloud, network resources are provisioned for exclusive use by a particular group of one or more entities (the term “entity” as used herein refers to a corporation, organization, person, or other entity). The network resources may be local to and/or remote from the premises of the particular group of entities. In a public cloud, cloud resources are provisioned for multiple entities that are independent from each other (also referred to as “tenants” or “customers”). The computer network and the network resources thereof are accessed by clients corresponding to different tenants. Such a computer network may be referred to as a “multi-tenant computer network.” Several tenants may use a same particular network resource at different times and/or at the same time. The network resources may be local to and/or remote from the premises of the tenants. In a hybrid cloud, a computer network comprises a private cloud and a public cloud. An interface between the private cloud and the public cloud allows for data and application portability. Data stored at the private cloud and data stored at the public cloud may be exchanged through the interface. Applications implemented at the private cloud and applications implemented at the public cloud may have dependencies on each other. A call from an application at the private cloud to an application at the public cloud (and vice versa) may be executed through the interface.

In an embodiment, tenants of a multi-tenant computer network are independent of each other. For example, a business or operation of one tenant may be separate from a business or operation of another tenant. Different tenants may demand different network requirements for the computer network. Examples of network requirements include processing speed, amount of data storage, security requirements, performance requirements, throughput requirements, latency requirements, resiliency requirements, Quality of Service (QOS) requirements, tenant isolation, and/or consistency. The same computer network may need to implement different network requirements demanded by different tenants.

In one or more embodiments, in a multi-tenant computer network, tenant isolation is implemented to ensure that the applications and/or data of different tenants are not shared with each other. Various tenant isolation approaches may be used.

In an embodiment, each tenant is associated with a tenant ID. Each network resource of the multi-tenant computer network is tagged with a tenant ID. A tenant is permitted access to a particular network resource only if the tenant and the particular network resources are associated with a same tenant ID.

In an embodiment, each tenant is associated with a tenant ID. Each application, implemented by the computer network, is tagged with a tenant ID. Additionally or alternatively, each data structure and/or dataset, stored by the computer network, is tagged with a tenant ID. A tenant is permitted access to a particular application, data structure, and/or dataset only if the tenant and the particular application, data structure, and/or dataset are associated with a same tenant ID.

As an example, each database implemented by a multi-tenant computer network may be tagged with a tenant ID. Only a tenant associated with the corresponding tenant ID may access data of a particular database. As another example, each entry in a database implemented by a multi-tenant computer network may be tagged with a tenant ID. Only a tenant associated with the corresponding tenant ID may access data of a particular entry. However, the database may be shared by multiple tenants.

In an embodiment, a subscription list indicates which tenants have authorization to access which applications. For each application, a list of tenant IDs of tenants authorized to access the application is stored. A tenant is permitted access to a particular application only if the tenant ID of the tenant is included in the subscription list corresponding to the particular application.

In an embodiment, network resources (such as digital devices, virtual machines, application instances, and threads) corresponding to different tenants are isolated to tenant-specific overlay networks maintained by the multi-tenant computer network. As an example, packets from any source device in a tenant overlay network may only be transmitted to other devices within the same tenant overlay network. Encapsulation tunnels are used to prohibit any transmissions from a source device on a tenant overlay network to devices in other tenant overlay networks. Specifically, the packets, received from the source device, are encapsulated within an outer packet. The outer packet is transmitted from a first encapsulation tunnel endpoint (in communication with the source device in the tenant overlay network) to a second encapsulation tunnel endpoint (in communication with the destination device in the tenant overlay network). The second encapsulation tunnel endpoint decapsulates the outer packet to obtain the original packet transmitted by the source device. The original packet is transmitted from the second encapsulation tunnel endpoint to the destination device in the same particular overlay network.

### 7. Miscellaneous; Extensions

Embodiments are directed to a system with one or more devices that include a hardware processor and that are configured to perform any of the operations described herein and/or recited in any of the claims below.

In an embodiment, a non-transitory computer readable storage medium comprises instructions which, when executed by one or more hardware processors, causes performance of any of the operations described herein and/or recited in any of the claims.

Any combination of the features and functionalities described herein may be used in accordance with one or more embodiments. In the foregoing specification, embodiments have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

### 8. Hardware Overview

According to one embodiment, the techniques described herein are implemented by one or more special-purpose computing devices. The special-purpose computing devices may be hard-wired to perform the techniques, or may include digital electronic devices such as one or more application-specific integrated circuits (ASICs), field programmable gate arrays (FPGAs), or network processing units (NPUs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, FPGAs, or NPUs with custom programming to accomplish the techniques. The special-purpose computing devices may be desktop computer systems, portable computer systems, handheld devices, networking devices or any other device that incorporates hard-wired and/or program logic to implement the techniques.

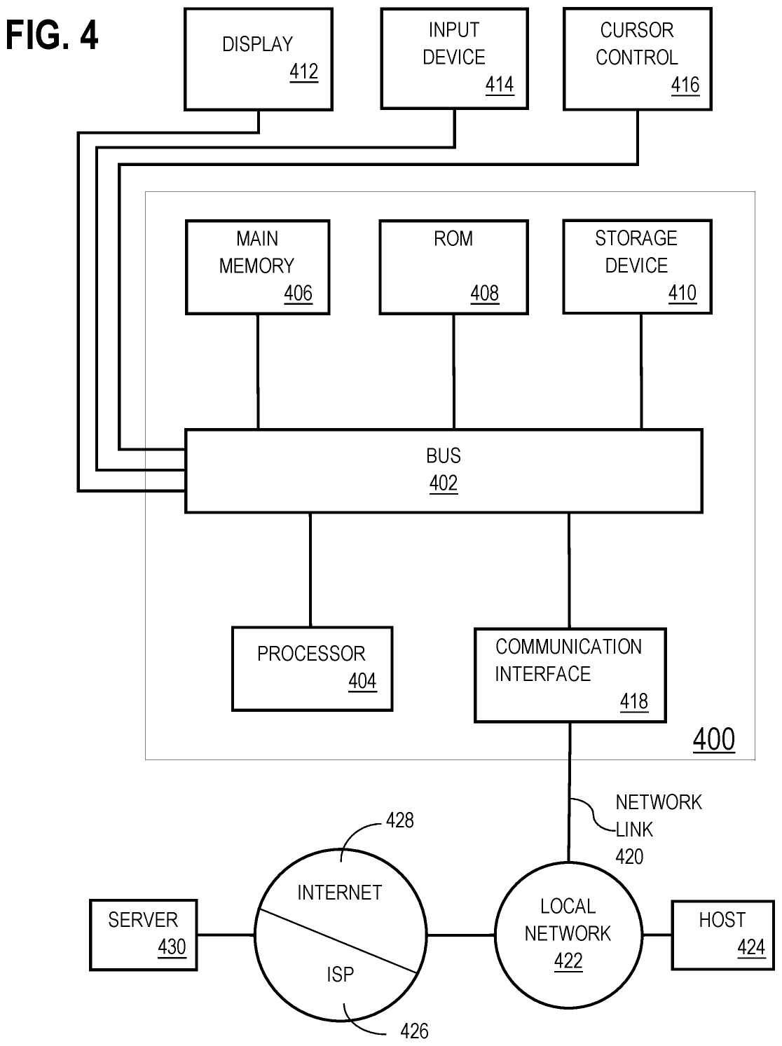

For example, FIG. 4 is a block diagram that illustrates a computer system 400 upon which an embodiment of the invention may be implemented. Computer system 400 includes a bus 402 or other communication mechanism for communicating information, and a hardware processor 404 coupled with bus 402 for processing information. Hardware processor 404 may be, for example, a general purpose microprocessor.

Computer system 400 also includes a main memory 406, such as a random access memory (RAM) or other dynamic storage device, coupled to bus 402 for storing information and instructions to be executed by processor 404. Main memory 406 also may be used for storing temporary variables or other intermediate information during execution of instructions to be executed by processor 404. Such instructions, when stored in non-transitory storage media accessible to processor 404, render computer system 400 into a special-purpose machine that is customized to perform the operations specified in the instructions.

Computer system 400 further includes a read only memory (ROM) 408 or other static storage device coupled to bus 402 for storing static information and instructions for processor 404. A storage device 410, such as a magnetic disk or optical disk, is provided and coupled to bus 402 for storing information and instructions.

Computer system 400 may be coupled via bus 402 to a display 412, such as a cathode ray tube (CRT), for displaying information to a computer user. An input device 414, including alphanumeric and other keys, is coupled to bus 402 for communicating information and command selections to processor 404. Another type of user input device is cursor control 416, such as a mouse, a trackball, or cursor direction keys for communicating direction information and command selections to processor 404 and for controlling cursor movement on display 412. This input device typically has two degrees of freedom in two axes, a first axis (c.g., x) and a second axis (e.g., y), that allows the device to specify positions in a plane.

Computer system 400 may implement the techniques described herein using customized hard-wired logic, one or more ASICs or FPGAs, firmware and/or program logic which in combination with the computer system causes or programs computer system 400 to be a special-purpose machine. According to one embodiment, the techniques herein are performed by computer system 400 in response to processor 404 executing one or more sequences of one or more instructions contained in main memory 406. Such instructions may be read into main memory 406 from another storage medium, such as storage device 410. Execution of the sequences of instructions contained in main memory 406 causes processor 404 to perform the process steps described herein. In alternative embodiments, hard-wired circuitry may be used in place of or in combination with software instructions.

The term “storage media” as used herein refers to any non-transitory media that store data and/or instructions that cause a machine to operate in a specific fashion. Such storage media may comprise non-volatile media and/or volatile media. Non-volatile media includes, for example, optical or magnetic disks, such as storage device 410. Volatile media includes dynamic memory, such as main memory 406. Common forms of storage media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge, content-addressable memory (CAM), and ternary content-addressable memory (TCAM).

Storage media is distinct from but may be used in conjunction with transmission media. Transmission media participates in transferring information between storage media. For example, transmission media includes coaxial cables, copper wire and fiber optics, including the wires that comprise bus 402. Transmission media can also take the form of acoustic or light waves, such as those generated during radio-wave and infra-red data communications.

Various forms of media may be involved in carrying one or more sequences of one or more instructions to processor 404 for execution. For example, the instructions may initially be carried on a magnetic disk or solid state drive of a remote computer. The remote computer can load the instructions into its dynamic memory and send the instructions over a telephone line using a modem. A modem local to computer system 400 can receive the data on the telephone line and use an infra-red transmitter to convert the data to an infra-red signal. An infra-red detector can receive the data carried in the infra-red signal and appropriate circuitry can place the data on bus 402. Bus 402 carries the data to main memory 406, from which processor 404 retrieves and executes the instructions. The instructions received by main memory 406 may optionally be stored on storage device 410 either before or after execution by processor 404.

Computer system 400 also includes a communication interface 418 coupled to bus 402. Communication interface 418 provides a two-way data communication coupling to a network link 420 that is connected to a local network 422. For example, communication interface 418 may be an integrated services digital network (ISDN) card, cable modem, satellite modem, or a modem to provide a data communication connection to a corresponding type of telephone line. As another example, communication interface 418 may be a local area network (LAN) card to provide a data communication connection to a compatible LAN. Wireless links may also be implemented. In any such implementation, communication interface 418 sends and receives electrical, electromagnetic or optical signals that carry digital data streams representing various types of information.

Network link 420 typically provides data communication through one or more networks to other data devices. For example, network link 420 may provide a connection through local network 422 to a host computer 424 or to data equipment operated by an Internet Service Provider (ISP) 426. ISP 426 in turn provides data communication services through the world wide packet data communication network now commonly referred to as the “Internet” 428. Local network 422 and Internet 428 both use electrical, electromagnetic or optical signals that carry digital data streams. The signals through the various networks and the signals on network link 420 and through communication interface 418, which carry the digital data to and from computer system 400, are example forms of transmission media.

Computer system 400 can send messages and receive data, including program code, through the network(s), network link 420 and communication interface 418. In the Internet example, a server 430 might transmit a requested code for an application program through Internet 428, ISP 426, local network 422 and communication interface 418.

The received code may be executed by processor 404 as it is received, and/or stored in storage device 410, or other non-volatile storage for later execution.

In the foregoing specification, embodiments of the invention have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

What is claimed is:

1. A non-transitory computer readable medium comprising instructions which, when executed by one or more hardware processors, causes performance of operations comprising:
generating training data sets at least by:
comparing a plurality of sets of time-series data to a set of feature-based rules, wherein each feature-based rule in the set of feature-based rules is mapped to a respective life-cycle classification;
based on detecting a match between a particular feature-based rule and one or more life-cycle-based features of a particular set of life-cycle-based features extracted from a particular set of time-series data: labeling the particular set of time-series data with a particular life-cycle classification mapped to the particular feature-based rule;
training a machine learning model to generate life-cycle classifications for product-store pairs, the training comprising:
obtaining the training data sets, each training data set comprising:
historical time-series data for a respective product-store pair; and
a life-cycle classification, corresponding to a life-cycle type, for the historical time-series data;
training the machine learning model based on the training data sets;
receiving a target set of time-series data for a target product-store pair; and
applying the machine learning model to the target set of time-series data to generate a particular life-cycle classification for the target product-store pair.

2. The non-transitory computer readable medium of claim 1, wherein the operations further comprise generating the training data sets at least by:
accessing the plurality of sets of time-series data corresponding to sales of one or more products from a plurality of stores; and
extracting a set of life-cycle-based features from each set of time-series data of the plurality of sets of time-series data by comparing characteristics of the time-series data to particular features to determine whether the features are present in the time-series data.

3. The non-transitory computer readable medium of claim 1, wherein comparing each set of time-series data of the plurality of sets of time-series data to a set of feature-based rules comprises:
comparing, in a predetermined sequence, the particular set of time-series data to a respective feature-based rule among the set of feature-based rules; and
based on detecting the match between the particular feature-based rule and the particular set of time-series data: refraining from comparing the particular set of time-series data to any additional feature-based rules among the set of feature-based rules.

4. The non-transitory computer readable medium of claim 1, wherein the machine learning model is a random forest classifier model.

5. The non-transitory computer readable medium of claim 1, wherein the particular life-cycle classification for the target product-store pair is a short-life-cycle classification, and
wherein the operations further comprise:
applying the machine learning model to a second set of time-series data associated with a second product-store pair to generate a second life-cycle classification for the second product-store pair, wherein the second life-cycle classification is a long-life-cycle classification.

6. The non-transitory computer readable medium of claim 5, wherein the target product-store pair corresponds to a first product sold from a first store, and
wherein the second product-store pair corresponds to the first product sold from a second store.

7. The non-transitory computer readable medium of claim 5, wherein the operations further comprise:
based on determining the target product-store pair corresponds to the short-life-cycle classification: applying a first forecasting model to a third set of time-series data associated with the target product-store pair to generate a first forecast for the target product-store pair; and
based on determining the second product-store pair corresponds to the long-life-cycle classification: applying a second forecasting model to a fourth set of time-series data associated with the second product-store pair to generate a second forecast for the second product-store pair.

8. The non-transitory computer readable medium of claim 7, wherein the operations further comprise:
applying the machine learning model to a fifth set of time-series data associated with a third product-store pair to generate a third life-cycle classification for the third product-store pair, wherein the third life-cycle classification is an inconclusive-type classification.

9. The non-transitory computer readable medium of claim 8, wherein the operations further comprise:
based on determining the third product-store pair corresponds to the inconclusive-type classification:
comparing attributes of the third product-store pair to attributes of at least one of the target product-store pair and the second product-store pair to assign an interim classification to the third product-store pair, wherein the interim classification corresponds to one of the long-life-cycle classification and the short-life-cycle classification; and
based on the interim classification: applying one of the first forecasting model and the second forecasting model to a sixth set of time-series data associated with the third product-store pair to generate a third forecast for the third product-store pair.

10. A method comprising:
generating training data sets at least by:
comparing a plurality of sets of time-series data to a set of feature-based rules, wherein each feature-based rule in the set of feature-based rules is mapped to a respective life-cycle classification;
based on detecting a match between a particular feature-based rule and one or more life-cycle-based features of a particular set of life-cycle-based features extracted from a particular set of time-series data: labeling the particular set of time-series data with a particular life-cycle classification mapped to the particular feature-based rule;
training a machine learning model to generate life-cycle classifications for product-store pairs, the training comprising:
obtaining the training data sets, each training data set comprising:
historical time-series data for a respective product-store pair; and
a life-cycle classification, corresponding to a life-cycle type, for the historical time-series data;
training the machine learning model based on the training data sets;
receiving a target set of time-series data for a target product-store pair; and
applying the machine learning model to the target set of time-series data to generate a particular life-cycle classification for the target product-store pair.

11. The method of claim 10, further comprising generating the training data sets at least by:
accessing the plurality of sets of time-series data corresponding to sales of one or more products from a plurality of stores; and
extracting a set of life-cycle-based features from each set of time-series data of the plurality of sets of time-series data by comparing characteristics of the time-series data to particular features to determine whether the features are present in the time-series data.

12. The method of claim 10, wherein comparing each set of time-series data of the plurality of sets of time-series data to a set of feature-based rules comprises:
comparing, in a predetermined sequence, the particular set of time-series data to a respective feature-based rule among the set of feature-based rules; and
based on detecting the match between the particular feature-based rule and the particular set of time-series data: refraining from comparing the particular set of time-series data to any additional feature-based rules among the set of feature-based rules.

13. The method of claim 10, wherein the machine learning model is a random forest classifier model.

14. The method of claim 10, wherein the particular life-cycle classification for the target product-store pair is a short-life-cycle classification, and
wherein the method further comprises:
applying the machine learning model to a second set of time-series data associated with a second product-store pair to generate a second life-cycle classification for the second product-store pair, wherein the second life-cycle classification is a long-life-cycle classification.

15. The method of claim 14, wherein the target product-store pair corresponds to a first product sold from a first store, and
wherein the second product-store pair corresponds to the first product sold from a second store.

16. The method of claim 14, further comprising:
based on determining the target product-store pair corresponds to the short-life-cycle classification: applying a first forecasting model to a third set of time-series data associated with the target product-store pair to generate a first forecast for the target product-store pair; and
based on determining the second product-store pair corresponds to the long-life-cycle classification: applying a second forecasting model to a fourth set of time-series data associated with the second product-store pair to generate a second forecast for the second product-store pair.

17. The method of claim 16, further comprising:
applying the machine learning model to a fifth set of time-series data associated with a third product-store pair to generate a third life-cycle classification for the third product-store pair, wherein the third life-cycle classification is an inconclusive-type classification.

18. The method of claim 17, further comprising:
based on determining the third product-store pair corresponds to the inconclusive-type classification:
comparing attributes of the third product-store pair to attributes of at least one of the target product-store pair and the second product-store pair to assign an interim classification to the third product-store pair, wherein the interim classification corresponds to one of the long-life-cycle classification and the short-life-cycle classification; and
based on the interim classification: applying one of the first forecasting model and the second forecasting model to a sixth set of time-series data associated with the third product-store pair to generate a third forecast for the third product-store pair.

19. A system comprising:
one or more processors; and
memory storing instructions that, when executed by the one or more processors, cause the system to perform operations comprising:
generating training data sets at least by:
comparing a plurality of sets of time-series data to a set of feature-based rules, wherein each feature-based rule in the set of feature-based rules is mapped to a respective life-cycle classification;
based on detecting a match between a particular feature-based rule and one or more life-cycle-based features of a particular set of life-cycle-based features extracted from a particular set of time-series data: labeling the particular set of time-series data with a particular life-cycle classification mapped to the particular feature-based rule;
training a machine learning model to generate life-cycle classifications for product-store pairs, the training comprising:
obtaining the training data sets, each training data set comprising:
historical time-series data for a respective product-store pair; and
a life-cycle classification, corresponding to a life-cycle type, for the historical time-series data;
training the machine learning model based on the training data sets;
receiving a target set of time-series data for a target product-store pair; and
applying the machine learning model to the target set of time-series data to generate a particular life-cycle classification for the target product-store pair.

20. The system of claim 19, wherein the operations further comprise generating the training data sets at least by:
accessing the plurality of sets of time-series data corresponding to sales of one or more products from a plurality of stores; and
extracting a set of life-cycle-based features from each set of time-series data of the plurality of sets of time-series data by comparing characteristics of the time-series data to particular features to determine whether the features are present in the time-series data.
